(19) United States
(12) Patent Application Publication
(10) Pub. No.: US 2007/0267866 A1
(43) Pub. Date: Nov. 22, 2007

(54) Conduit clamp

(75) Inventors: Robert K. Jolly, Cordova, TN (US); Mark R. Drane, Germantown, TN (US)

Correspondence Address: HOFFMAN & BARON, LLP, 6900 JERICHO TURNPIKE, SYOSSET, NY, 11791, US

(73) Assignee: Thomas & Betts International, Inc.

(21) Appl. No.: 11/800,158

(22) Filed: May 4, 2007

Related U.S. Application Data
(60) Provisional application No. 60/802,236, filed on May 19, 2006.

(51) Int. Cl. F16L 41/00

(52) U.S. Cl. 285/207

(57) ABSTRACT

A conduit clamp having a front clamp half and a rear clamp half, together forming power and communication conduit supports for a plurality of conduits. When the plurality of conduits extend vertically, at least one of the conduit supports engages a communications conduit at a different elevation than another conduit support engages a power conduit. The first and second clamp halves of the conduit clamp are affixed together via a plurality of fasteners. One of the plurality of fasteners can be loosened to release engagement of the conduit clamp against one of the plurality of conduits so that the power and communication conduit supports are each separately and individually adjustable within the conduit clamp.

This application claims priority from provisional application Ser. No. 60/802,236, filed on May 19, 2006, which is incorporated herein in its entirety.

### FIELD OF THE INVENTION

This invention pertains to a conduit clamp for multiple conduits that can be used in conjunction with a poke-through electrical floor box. In particular, the invention pertains to a conduit clamp for multiple conduits that allows independent adjustment of the individual conduits.

### BACKGROUND OF INVENTION

It is well known to employ conduit clamps for supporting multiple conduits in conjunction with a poke-through electrical floor box. However, while these conduit clamps provide support for three separate conduits feeding the poke-through box, they do not allow individual adjustment of any one of the conduits. Generally, poke-through clamps are designed so that in order to loosen the support for one conduit, the supports for the other conduits must also be loosened. These designs do not allow a single conduit to be adjusted while the other conduits are securely held in place by the clamp.

Clamps that can be used for securing three conduits (also referred to herein as “three-conduit clamps”) are well known. There are even some three-conduit clamps that allow each of the conduits to be individually adjusted, but they are not suitable for use with poke-through electrical floor boxes. U.S. Pat. No. 5,035,383 to Rainville is an example of an individually adjustable three-conduit clamp. The three individual clamps disclosed in this patent are designed to engage conduits which are not all in the same longitudinal plane (i.e., the longitudinal axes of the conduits are not in the same plane). The clamp secures the three conduits so that the longitudinal axes form a triangle and are not all lined up in a row, as is usually required for poke-through electrical floor boxes. U.S. Pat. No. 3,526,934 to Owen does show a conduit clamp that is designed to secure conduits arranged all in a row, but the clamp cannot individually release or adjust a single conduit. In order to adjust any of the conduits, the clamp must be loosened and restraint on the entire row of conduits released.

In both of the above designs, the clamping forces on all three conduits are applied at the same elevation. This results in the shortcomings described above, i.e. not being able to individually clamp three conduits arranged in a row (the Rainville '383 patent), or not being able to individually adjust a single conduit without disturbing the others (the Owen '934 patent). These disadvantages in the prior art designs make existing multiple-conduit clamps inadequate for use with poke-through electrical floor boxes.

Thus, it is an object of this invention to provide a multiple-conduit clamp for use with poke-through electrical floor boxes. It is yet another object of this invention to provide a clamp whereby a single conduit can be individually adjusted or moved without disturbing or releasing restraint on adjacent conduits. Still another object of this invention is to provide a clamp whereby the individual conduit clamping locations are at different elevations, even though the conduits are aligned in a row. A further object of this invention is to provide a conduit clamp that employs two separate clamp halves as well as the necessary hardware or fasteners for joining the two halves.

### SUMMARY OF THE INVENTION

In accordance with the present invention, a conduit clamp for supporting both power and communications conduits, such as those extending from a poke-through electrical floor box, is provided. In one embodiment, the conduit clamp includes a front clamp half and a rear clamp half, together forming power and communication conduit supports for a plurality of conduits. When the plurality of conduits extend vertically, at least one of the conduit supports engages a communications conduit at a different elevation than another conduit support engages a power conduit. The first and second clamp halves of the conduit clamp are affixed together via a plurality of fasteners. One of the plurality of fasteners can be loosened to release engagement of the conduit clamp against one of the plurality of conduits so that the power and communication conduit supports are each separately and individually adjustable within the conduit clamp.

The first and second clamp halves of the conduit clamp can contain inter-mating alignment structure that facilitate joining and aligning the two halves. Preferably, the conduit clamp is ‘T’ shaped. At least one communication conduit is supported by a communication conduit support along the cross-bar of the ‘T’ and the power conduit is supported by a power conduit support (also referred to herein as the lower conduit support) along the stem of the ‘T.’ The communication conduit support and the power conduit support are interconnected via one or more bridges, which can be flexible so that the communication conduit support and the power conduit support can accommodate conduits having different outside diameters. When at least one of the communication conduit supports is of a different size (i.e., has a different diameter) than the power conduit support, the flexible bridge (or bridges) can interconnect the differently sized supports.

The conduit clamp can include a power conduit passageway that is axially aligned with the power conduit support (i.e., the axes of the passageway and the power conduit support are concentric). The power conduit passageway is larger in diameter than the power conduit support so that the power conduit can unrestrictedly pass through the passageway. Preferably, the power conduit passageway is located at the same elevation as and intermediate a pair of communication conduit supports.

In another embodiment, the conduit clamp includes: a first clamp section having a center aperture and two outer apertures; a second clamp section having a lower aperture, wherein the center aperture and the lower aperture are substantially coaxial; a first flexible bridge connecting the first and second clamp sections; and a plurality of fasteners, wherein the fasteners are tightened to independently secure one or more conduits in one or both of the outer apertures and/or the lower aperture. The first clamp section includes a front clamp component and a rear clamp component and the second clamp section includes a front clamp member and a rear clamp member. When the fasteners are tightened to secure the conduits, they also join the front clamp component with the rear clamp component and the front clamp member with the rear clamp member. The conduit clamp can also include a second flexible bridge. The first and second flexible bridges connect the front and rear clamp components to the front and rear clamp members, respectively.

The first clamp section has a vertical axis and a horizontal axis and the horizontal axis passes through each aperture (i.e., the center aperture and, the outer apertures). The first and second clamp sections are aligned so that the vertical axis of the first section passes through the lower aperture in the second section. In addition, the first and second clamp sections of the conduit clamp have a plurality of fastener apertures, which receive a plurality of fasteners, such as bolts or screws. The front and rear clamp components can include one or more inter-mating alignment structure that assist the user in aligning the fastener apertures in the front and rear clamp components and members.

In one embodiment, either or both the front and rear clamp components has/have a pair of opposing ends that are pivotally connected, preferably by first and second hinges. The first and second hinges are located about midway between the opposing ends of the front and rear clamp components, respectively. The conduit clamp has at least one fastener associated with and located near each of the outer apertures and tightening the fastener prevents pivotal movement of the associated opposing end.

### BRIEF DESCRIPTION OF THE FIGURES

The preferred embodiments of the conduit of the present invention, as well as other objects, features and advantages of this invention, will be apparent from the accompanying drawings wherein:

FIG. 1 is a perspective view of the conduit clamp installed under a poke-through electrical floor box and clamping three conduits together.

FIG. 2 is an enlarged perspective front view of the conduit clamp securing three adjacent conduits together.

FIG. 3 is an enlarged perspective back view of the conduit clamp securing three adjacent conduits together.

FIG. 4 is an exploded perspective view of the conduit clamp showing the first and second halves and the screws that fasten them together.

FIG. 5 is a perspective view of the interior side of the first half of the conduit clamp.

FIG. 6 is a top view of the conduit clamp with the first and second halves assembled together.

FIG. 7 is a bottom view of the conduit clamp with the first and second halves assembled together.

### DETAILED DESCRIPTION OF THE INVENTION

The present invention is a conduit clamp that secures a plurality of power and communication conduits in such a manner that each conduit can be independently tightened and loosened. The conduit clamp is particularly well suited for use with a poke-through electrical floor box, which typically has three conduits entering the bottom of the box in close proximity, with one conduit used for power and the other two conduits used for communication signals. However, the conduit clamp is not limited to use with poke-through electrical boxes, nor the type of wiring in the conduits, and can be used in any application that requires multiple conduits to be securely held in place.

The conduit clamp has first and second clamp halves that are joined together to form first and second clamp sections with independently adjustable conduit supports for a plurality of power and/or communication conduits. The first and second clamp halves have substantially similar and corresponding shapes so that they are easily joined together to form the conduit clamp. The first and second clamp halves each have an upper portion (also referred to herein as front and rear clamp components, respectively) and a lower portion (also referred to herein as front and rear clamp members, respectively) that are connected by a flexible bridge, which is described in more detail below. The front and rear clamp components join together to form the first clamp section and the front and rear clamp members join together to form the second clamp section. Each of the clamp halves also has an interior side and an exterior side, wherein the interior sides come in contact when the clamp halves are joined.

In one embodiment, the conduit clamp has three conduit supports, two outer conduit supports in the first clamp section and a center conduit support in the second clamp section. The first clamp section has an aperture or passageway, preferably between the two outer conduit supports, that is aligned with the center conduit support in the second clamp section (also referred to herein as the lower conduit support) and that has a diameter greater than the diameters of the outer conduit supports. When conduits are secured in the outer conduit supports, the aperture/passageway allows conduits secured in the center conduit support to pass through the first clamp section without restriction. After the center conduit is in the desired position, the center conduit support is tightened and the conduit is secured in place.

The two clamp sections include a plurality of independently adjustable conduit supports which allow the support for one conduit to be tightened or loosened without affecting the other conduits supported by the clamp. When the plurality of conduits extend vertically, which is the case when conduits are connected to a poke-through electrical floor box, at least one of the conduit supports in the first clamp section engages a first conduit at a different elevation than another conduit support in the second clamp section engages a second conduit. In preferred embodiments, the center (i.e. lower) conduit support in the second clamp section engages a center conduit and unrestrictedly passes through the aperture in the first clamp section, while the two outer supports independently engage communication conduits.

In a preferred embodiment, the upper portion of each clamp half has three semicircular regions on the interior side that extend from the top surface to the bottom surface and the lower portion of each clamp section has one semicircular region that extends from the top surface to the bottom surface. When the first and second clamp halves are joined together, the interior sides contact each other and the upper portions of the clamp halves form the first clamp section and the lower portions of the clamp halves form the second clamp section. The three semicircular regions in each of the upper portions are correspondingly located so that, when the two clamp halves are joined together, the semicircular regions form three apertures (referred to herein as the center aperture and two outer apertures) with parallel axes in the first clamp section. The outer apertures are used for the outer conduit supports and the center aperture/passageway is located intermediate the outer apertures. Similarly, the semicircular regions in the lower portions (i.e., the front and rear clamp members) are correspondingly located and form the center/lower conduit support in the second clamp section when the two clamp halves are joined together.

Each of the semicircular regions that form the outer and center/lower conduit supports in the first and second clamp sections, respectively, can have upper and lower engaging flanges. The flanges extend from the top and bottom surfaces of the first and second clamp components and the first and second clamp members and define a recessed area in each of the semicircular regions. When a conduit is secured in one of the conduit supports, it is engaged by the side surfaces of the flanges. In a preferred embodiment, the side surfaces of the flanges have a series of ridges that help to grip the conduit when the clamp is tightened and prevent the conduit from slipping through the conduit support.

The conduit clamp includes a plurality of fasteners that affix the first and second clamp halves together and independently secure the conduits in the conduit supports. One or more fasteners in the first clamp section are tightened to secure conduits in each of the outer conduit supports and, at the same time, affix the upper portions of the first and second clamp halves (i.e., the front and rear clamp components) together. The fasteners can be loosened to independently disengage the conduits from the outer conduit supports so that one or both of the conduits can be freely moved without restriction. Similarly, one or more fasteners in the second clamp section are tightened to secure a conduit in the center conduit support and affix lower portions of the first and second clamp halves (i.e., the front and rear clamp members) together. The fasteners can be loosened to disengage the conduit from the center/lower conduit support so that the conduit can be freely moved without restriction. Moreover, since the diameter of the center aperture in the first clamp section is larger than the outside diameter of the conduit, the fasteners in the first clamp section do not have to be loosened to allow the conduit in the center/lower conduit support to be freely moved.

Preferably, the first and second clamp sections are provided with at least two fasteners and each conduit support has at least one fastener associated with it for securing the conduits. The first clamp section has at least one fastener on either side of the center aperture and the second clamp section has at least one fastener on either side of the center/lower conduit support. A variety of different fasteners and configurations can be used. In one embodiment, the first and second clamp halves have apertures at corresponding locations so that a bolt or screw can pass through both halves and be secured by a nut. In another embodiment, one of the clamp halves has an aperture and the other clamp half has a tapped (also referred to as threaded) hole. A screw or bolt passes through the aperture and is screwed into the tapped hole. The screws in the first clamp section are loosened to release the conduits secured by the outer conduit supports and the screws in the second clamp section are loosened to release the conduit secured by the center/lower conduit support. This allows separate and individual adjustment of each of the conduits within the conduit clamp.

In a preferred embodiment, the first and second clamp halves of the conduit clamp include one or more inter-mating alignment structure, which allow the two halves to be properly aligned so that the fasteners can be quickly and easily inserted into the apertures. The inter-mating alignment structures are formed at corresponding locations on the interior sides of the two clamp halves that contact each other when they are joined together. Such inter-mating alignment structure are well known to those skilled in the art and, typically, include one or more bumps or protrusions on one of the clamp halves that correspond to one or more cavities in the other clamp half. When the two clamp halves are joined together, the cavities receive the bumps or protrusions and confirm to the user that the clamp halves are properly aligned.

The conduit clamp has a ‘T’ with the cross-bar of the ‘T’ formed by the first clamp section having the two outer clamp supports and the center aperture/passageway. The vertical portion or stem of the ‘T’ is formed by the second clamp section having the center/lower conduit support. In preferred embodiments, at least one communication conduit is supported by one of the outer conduit supports along the cross-bar of the ‘T’ and a center conduit is supported by the center/lower conduit support in the stem of the ‘T.’ The outer conduit supports and the center/lower conduit support are connected along the stem of the ‘T’ by a bridge. The bridge is flexible so that the conduit clamp can accommodate and individually adjust conduits having different diameters. The bridge can flex either inwardly or outwardly, depending on whether the conduit in the center/lower conduit support is smaller than or larger than the conduits in the outer conduit supports. If all of the conduits are the same size, the bridge does not have to flex. The bridge is preferably made from a flexible piece of metal, an elastomer or a plastic.

In one embodiment, the center conduit is a power conduit and the center aperture/passageway in the first clamp section is axially aligned with the center/lower conduit support in the second clamp section. The center aperture/passageway is larger in diameter than the center/lower conduit support so that the center conduit can pass through the first clamp section without interference. This allows the center/lower conduit support to be independently adjusted without affecting the conduits secured in the outer conduit supports in the first section. The center conduit unrestrictedly passes through the center aperture/passageway, which is located at the same elevation as and intermediate the pair of outer conduit supports.

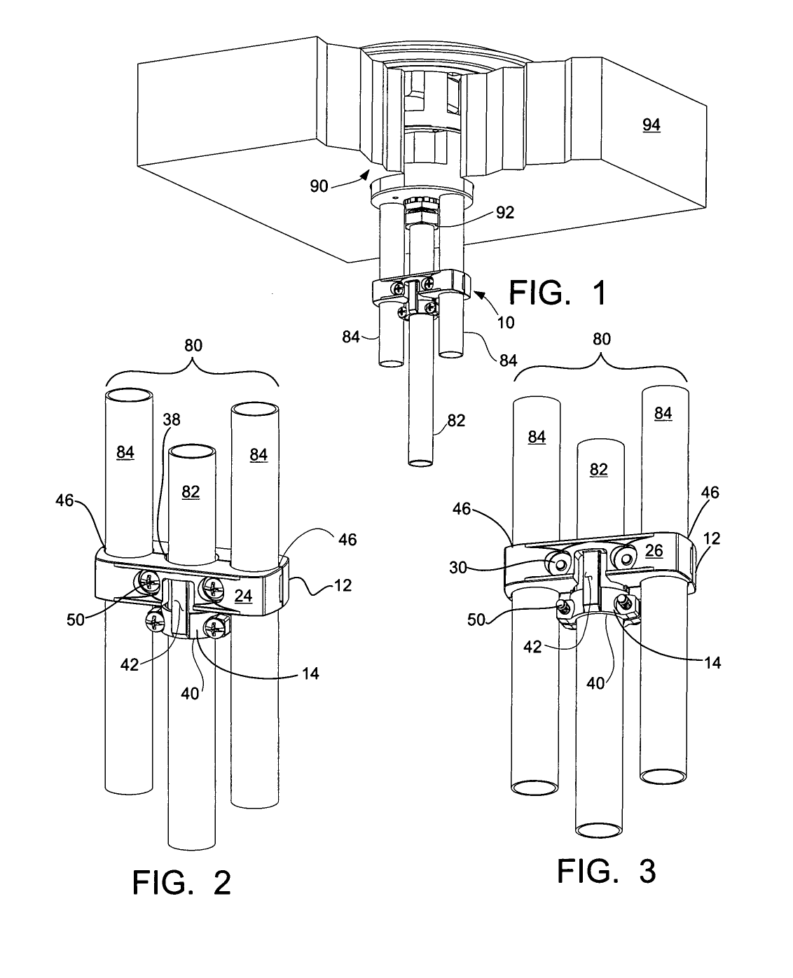

Referring to the drawings, one embodiment of the conduit clamp 10 of the present invention is shown in FIG. 1. The conduit clamp 10 is preferably used in conjunction with a poke-through electrical floor box 90. Typically, wiring to and/or from the floor box 90 comes from underneath the floor 94 and is contained in more than one conduit 80 (see FIG. 2). Generally, power or high voltage wiring is located in the center conduit 82, while communication or low voltage wiring is located in the outer two conduits 84 (also referred to in describing the figures as the communication conduits 84). However, it is understood that the arrangement of the conduits 80 and the wiring contained therein can vary depending on the electrical devices housed in the floor box 90 and the user's preference, and that such arrangement is not a limitation of the present invention.

While not shown in the drawings, center/power conduit 82 typically extends a distance underneath the floor 94 and connects to a junction box where power wiring is connected. Also, not shown in the drawings are connection fittings that couple low voltage conduit runs to communications conduit 84. Both the junction box and these connection fittings are typically located underneath the clamp 10, rather than intermediate the clamp 10 and the floor 94.

FIG. 1 shows fitting 92 at the base of the floor box 90, which secures the center conduit 82 to the floor box 90. Once the center conduit 82 is affixed to the box 90, it can act as the supporting structure for the adjacent conduits 84 when the adjacent conduits 84 are secured in clamp 10. As those of ordinary skill in the art understand, communication conduits 84 are typically not rigidly secured to box 90, but instead are inserted into the box 90 or abut the bottom of the floor box 90. Thus, the communication conduits 84 are not supported by the box 90 as is the center conduit 82.

Thus, a conduit clamp 10 that can support the communication conduit 84 and permit adjustment of individual conduits without affecting the support of adjacent conduits is desirable. It is also desirable to accomplish this within the confines or limitations typically imposed by a poke-through electrical floor box 90. Preferably, the conduit clamp 10 is made from a metallic material, but it can also be made from a non-metallic material, such as a plastic.

FIG. 2 shows the front half 24 of the conduit clamp 10 with three conduits 80 secured in the conduit supports 40, 46. A plurality of screws 50 are tightened to secure the conduits 80 in the clamp 10. The conduit aperture/passageway 38 in the first clamp section 12 allows the center conduit 82 to freely pass through the first clamp section 12. This allows the screws 50 securing the center conduit 82 to be loosened and the position of the center conduit 82 adjusted without loosening the conduit supports 46 for the outer conduits 84. Similarly, the screws 50 securing one or both of the outer conduits 84 can be loosened and the conduits 84 adjusted without having to loosen the screws 50 that secure the center conduit 82.

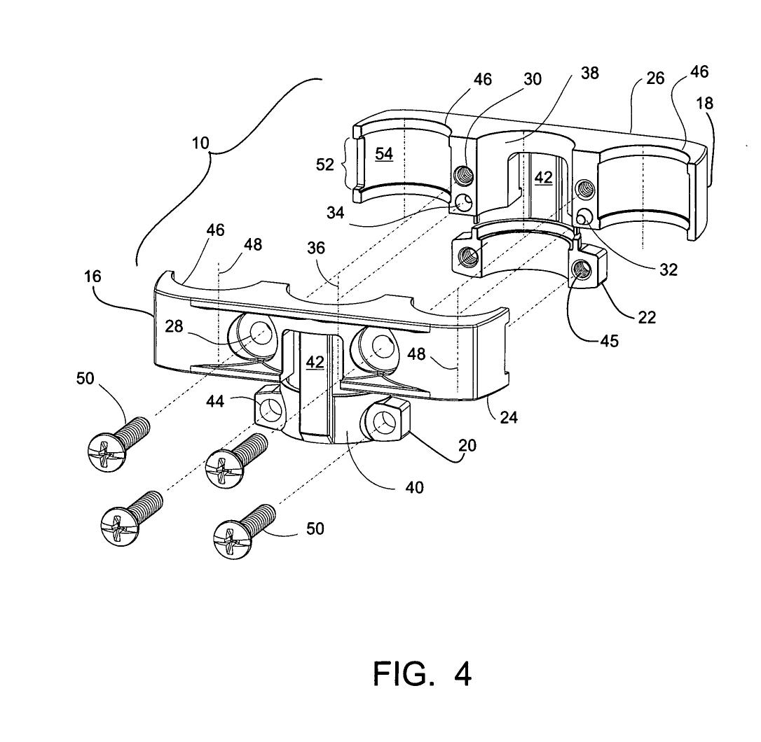

FIG.3 shows the rear half 26 of the conduit clamp 10 with three conduits 80 secured in the conduit supports 40, 46. The screws 50 freely pass through the thru-screw (i.e., unthreaded) holes 28, 44 in the front half 24 (see FIG. 4) and then engage the threaded holes 30, 45 in the rear half 26. The center conduit 82 is secured in the lower/center conduit support 40 of the second clamp section 14 by two screws 50 on either side. A pair of screws 50 on either side of the passageway 38 of the first clamp section 12 are used to secure the conduits 84 in the outer conduit supports 46.

Referring now to FIG. 4, the conduit clamp 10 includes two clamp halves 24, 26 (also referred to herein as the front clamp half and the rear clamp half). These clamp halves 24, 26 are substantially mirror images of each other, but there are several differences that are illustrated in FIG. 4. These differences relate primarily to the manner of securing the two halves 24, 26 together, i.e., the front clamp half 24 has thru-screw holes 28, which allow the fastening screws 50 to pass through, while the rear clamp half 26 has threaded screw holes 30, which receive the fastening screws 50. Both of the clamp halves 24, 26 also include an alignment protrusion 32 and a mating alignment cavity 34. The alignment protrusion 32 on one of the clamp halves 24, 26 corresponds to the mating alignment cavity 34 on the other clamp half 24, 26, so that their respective inter-engagement properly aligns the clamp halves 24, 26 with respect to each other. Other methods of accomplishing the alignment of the clamp halves 24, 26 are possible and the invention is not limited by the method that is used to align the clamp halves 24, 26. The objective being to achieve the proper alignment of the thru-screw holes 28 with the threaded screw holes 30 in a quick and easy manner.

As shown in FIG. 4, each clamp half 24, 26 is ‘T’ shaped with the stem or vertical member of the ‘T’ formed by the front or rear clamp member 20, 22 and the horizontal bar of the ‘T’ formed by the front or rear clamp component 16, 18. When the clamp halves 24, 26 are joined together, the conduit aperture/passageway 38 in the first clamp section 12 and the center/lower conduit support 40 in the second clamp section 14 are axially aligned. The aperture/passageway 38 has a larger diameter than the center/lower support 40 so that, when the clamp 10 is tightened, the aperture/passageway 38 does not restrict the movement of the center conduit 82 (see FIGS. 1-3). Instead, the center conduit 82 is engaged by the center/lower conduit support 40 in the second clamp section 14 and freely passes through the first clamp section 12.

The front and rear clamp components 16, 18, which form the first clamp section 12, and the front and rear clamp members 20, 22, which form the second clamp section 14, are connected by first and second flexible bridges 42, respectively. If the center conduit 82 has a larger diameter than the outer conduits 84, the flexible bridges 42 move outwardly from the axis of the center conduit 82 and allow the lower support 40 to independently secure the center conduit 82, while the first clamp section 12 independently secures the communications conduits 84.

As shown in FIG. 4, the front clamp member 20 has thru-screw (i.e., unthreaded) holes 44 on opposite sides of the center/lower conduit support 40, which allow screws 50 to pass through without restriction. The rear clamp member 22 has threaded holes 45, which are used to join the clamp members 24, 26 together and secure the center conduit 82 therebetween. Since the center conduit 82 is typically attached to an electrical box 90 (see FIG. 1), the center conduit 82 provides support for the clamp 10 once the center conduit 82 is secured in the center/lower conduit support 40. It then becomes possible for the clamp 10 to secure and support one or more communication conduits 84 using communication conduit supports 46 located on either side of the aperture/passageway 38. These supports 46 are similar to the center/lower conduit support 40 and they are sized to engage and secure the communication conduits 84. The conduit supports 46 have axes 48 that are parallel with the longitudinal (or vertical) axis 36 of the center aperture/passageway 38 and, in the embodiment shown in the figures, all of the axes 36, 48 are in the same plane. In the embodiment shown in FIG. 1, the communication conduits 84 are engaged or supported at one elevation (via support 46 in the first clamp section 12), while the center conduit 82 is engaged or supported at a different elevation (via the center/lower conduit support 40 in the second clamp section 14).

Each outer conduit support 46 is shaped for engaging and supporting a conduit 84 therein, preferably a conduit 84 for communications wiring (see FIG. 1). In the embodiment shown in FIG. 4, the alignment protrusions 32 and alignment cavities 34 are located intermediate the passageway 38 and the outer conduit supports 46, but other configurations are within the scope of the invention. Also, intermediate the center aperture/passageway 38 and the outer conduit supports 46 are the screw holes 28, 30. The front clamp half 24 has a thru screw hole 28 and the rear clamp half 26 has a threaded screw hole 30. The screws 50 pass unrestrictedly through the thru screw holes 28 in the front clamp component 16 and engage the threaded screw holes 30 in the rear clamp component 18. Similarly, the screws 50 pass unrestrictedly through the thru screw hole 44 in the front clamp member 20 and engage the threaded screw holes 45 in the rear clamp member 22. Tightening the screws 50 joins the front clamp half 24 and the rear clamp half 26 together. The screws 50 are located near and associated with the conduit supports 40, 46 so that one screw 50 secures one communications conduit 84 to one outer conduit support 46 while another screw 50 secures the other communications conduit 84 to the other outer conduit support 46.

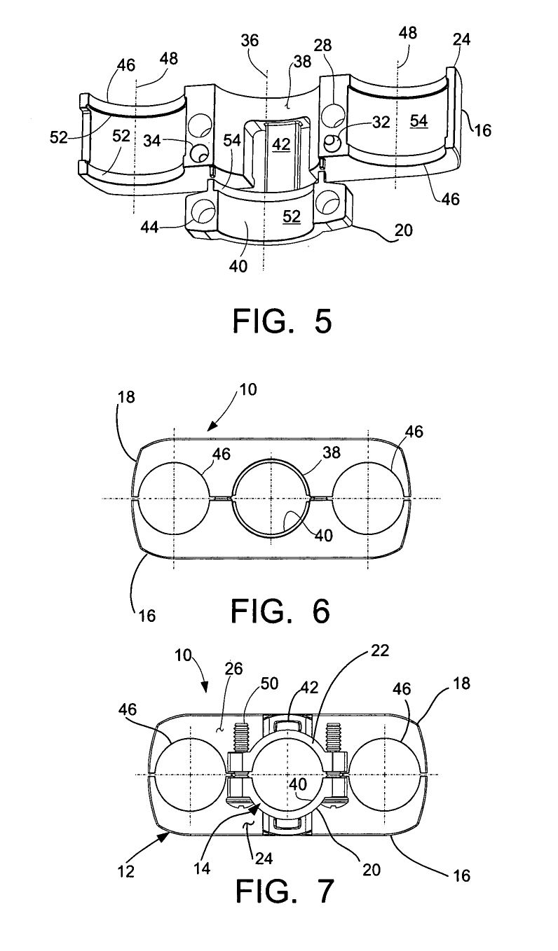

The clamp 10 is configured so that one screw 50 can be loosened to independently adjust one of the communications conduits 84 secured in an outer conduit support 46 without affecting or loosening the outer conduit support 46 for the other communications conduit 84. Moreover, loosening the screws 50 that secure the communications conduits 84 to the clamp 10 does not affect the support for the clamp 10, which is firmly secured to the center conduit 82 via the center/lower conduit support 40 in the second clamp section 14 (see FIGS. 1-3). As shown in FIGS. 4 and 5, flexible bridge 42 provides the supporting connection between the first clamp section 12 and the second clamp section 14. In a preferred embodiment, a hinge (not shown) is located in the front and/or rear clamp component 16, 18 intermediate the opposing outer conduit supports 46. Thus, when the screw 50 associated with one of the communication conduits 84 is loosened, the clamp half 24, 26 can be pivoted so that the communications conduit 84 can be easily removed from the clamp 10.

While the screws 50 and the thru holes 28, 44 and threaded holes 30, 45 are described in detail herein, it is understood that different fastener types are equally suitable for securing the clamp halves 24, 26 together. The only requirement for the fasteners is that they are capable of independent operation so that individual conduits 80 can be separately adjusted as needed without releasing the other conduits 80 secured in the clamp 10.

As shown in the embodiment illustrated in FIGS. 4 and 5, the outer conduit supports 46 in the first clamp section 12 can include upper and lower engaging flanges 52. The engaging flanges 52 extend inwardly on the surfaces where the front and rear clamp components 16, 18 contact each other and, when the screw 50 associated with the outer conduit support 46 is tightened, the engaging flanges 52 contact the conduit 84 positioned therebetween. Intermediate the upper and lower engaging flanges 52 is a recessed area 54 that does not generally contact the conduit 84. Similarly, while not shown, the center/lower conduit support 40 in the second clamp section 14 can include inwardly extending upper and lower engaging flanges 52 that contact the center conduit 82 and also have an adjacent recessed area 54 therebetween. What is shown is a single wide flange 52 with no adjacent recessed area 54. Other configurations or methods of engaging the conduits 80 are within the scope of the invention and well know to those skilled in the art and the manner in which the conduit supports 40, 46 secure the conduits to the clamp 10 is not a limitation to the invention.

FIG. 6 shows the top of the first clamp section 12 with the aperture/passageway 38 for the center conduit 82 disposed between the outer conduit supports 46 (see FIGS. 1-3). The diameter of the aperture/passageway 38 in the first clamp section 12 is slightly larger than the diameter of the center/lower conduit support 40 in the second clamp section 14 (see FIG. 7). When a center conduit 82 is secured in the second clamp section 14 (see FIGS. 1-3) by the center/lower conduit support 40, the center conduit 82 passes unrestrictedly through the passageway 38 in the first conduit section 12. This allows the center/lower conduit clamp 40, which secures the center conduit 82 at a first elevation, to be loosened without loosening the outer conduit supports 46 in the first clamp section 12, which support the communication conduits 84 at a second elevation. While the figures show the three conduit supports 40, 46 that engage the conduits 82, 84, respectively, are all the same size, this is not intended to be a limitation and each of the conduit supports 40, 46 can have different sizes so that they can be used with conduits 80 having a variety of diameters. After the clamp 10 is installed on the conduits 80, each of the conduits 80 can be adjusted independently by loosening only a single screw 50 (see FIG. 2).

During installation, the position of the clamp 10 can be adjusted by moving or sliding the clamp 10 along the conduits 82, 84 to the desired elevation. This is done before the screws 50 joining the two clamp halves 24, 26 are fully tightened and after the clamp halves 24, 26 are aligned using the alignment guides 32, 34. After the clamp 10 is positioned at the desired location, the screws 50, and particularly the screws 50 associated with the center/lower conduit support 40, are tightened to securely affix the clamp 10 to the center conduit 82. Then, the outer/communication conduits 84 can be independently adjusted, by loosening and/or tightening the respective screws 50, without affecting the other outer/communication conduit 84. Again, the reason one of the communication conduits 84 may need adjustment is that these conduits 84 are not secured to the floor box 90 as is the center conduit 82. Instead, the communication conduits 84 slide into or are pushed upward against box 90 and, hence, the possible need for adjustment.

While select preferred embodiments of this invention have been illustrated, many modifications may occur to those skilled in the art and, therefore, it is to be understood that these modifications are incorporated within these embodiments as if they were fully illustrated and described herein.

We claim:

1. A conduit clamp for power and communication conduits comprising a front clamp half and a rear clamp half, together forming power and communication conduit supports for a plurality of conduits, wherein when the plurality of conduits extend vertically, at least one of the conduit supports engages a communications conduit at a different elevation than another conduit support engages a power conduit.

2. The conduit clamp as set forth in claim 1, wherein the first and second clamp halves are affixed together via a plurality of fasteners, and wherein one of the plurality of fasteners can be loosened to release engagement of the conduit clamp against one of the plurality of conduits.

3. The conduit clamp as set forth in claim 2, wherein the power and communication conduit supports are each separately and individually adjustable within the conduit clamp.

4. The conduit clamp as set forth in claim 3, wherein the first and second clamp halves contain inter-mating alignment structure.

5. The conduit clamp as set forth in claim 4, wherein the conduit clamp is ‘T’ shaped.

6. The conduit clamp as set forth in claim 5, wherein at least one communication conduit is supported by a communication conduit support along the cross-bar of the ‘T’ and wherein the power conduit is supported by a power conduit support along the stem of the ‘T.’

7. The conduit clamp as set forth in claim 6, wherein the communication conduit support and the power conduit support are interconnected via one or more bridges.

8. The conduit clamp as set forth in claim 7, wherein the one or more bridges is/are flexible.

9. The conduit clamp as set forth in claim 8, wherein at least one communication conduit support is of a different size than the power conduit support, and wherein the one or more flexible bridges can interconnect the differently sized supports.

10. The conduit clamp as set forth in claim 8, further comprising a power conduit passageway axially aligned with the power conduit support, the power conduit passageway being larger in diameter than the power conduit support.

11. The conduit clamp as set forth in claim 10, wherein the power conduit passageway is located at the same elevation as and intermediate a pair of communication conduit supports.

12. A conduit clamp comprising:
a first clamp section having a center aperture and two outer apertures;
a second clamp section having a lower aperture, wherein the center aperture and the lower aperture are substantially coaxial;
a first flexible bridge connecting the first and second clamp sections; and
a plurality of fasteners, wherein the fasteners are tightened to independently secure one or more conduits in one or both of the outer apertures and/or the lower aperture.

13. The conduit clamp as set forth in claim 12, wherein the first clamp section is comprised of a front clamp component and a rear clamp component.

14. The conduit clamp as set forth in claim 13, wherein the second clamp section is comprised of a front clamp member and a rear clamp member and wherein the plurality of fasteners join the front clamp component with the rear clamp component and the front clamp member with the rear clamp member.

15. The conduit clamp as set forth in claim 14, further comprising a second flexible bridge, wherein the first and second flexible bridges connect the front and rear clamp components to the front and rear clamp members, respectively.

16. The conduit clamp as set forth in claim 12, wherein the center aperture is larger than the outer apertures.

17. The conduit clamp as set forth in claim 12, wherein the first clamp section has a vertical axis and a horizontal axis, and wherein the horizontal axis passes through each aperture in the first section.

18. The conduit clamp as set forth in claim 17, wherein the vertical axis of the first section passes through the lower aperture in the second section.

19. The conduit clamp as set forth in claim 12, wherein the center aperture is larger than the lower aperture.

20. The conduit clamp as set forth in claim 13, wherein the front clamp component and/or the rear clamp component has/have a pair of opposing ends that are pivotally connected.

21. The conduit clamp as set forth in claim 20, wherein the opposing ends of the front and/or rear clamp components is/are pivotally connected by a hinge or hinges.

22. The conduit clamp as set forth in claim 21, wherein at least one fastener is associated with each of the outer apertures and tightening the at least one fastener prevents pivotal movement of the associated opposing end.

23. The conduit clamp as set forth in claim 21, wherein the hinge or hinges is/are located about midway between the opposing ends of the front and/or rear clamp components.

24. The conduit clamp as set forth in claim 12, wherein the first and second clamp sections have a plurality of fastener apertures.

25. The conduit clamp as set forth in claim 13, wherein the front and rear clamp components contain one or more inter-mating alignment structure.

26. A conduit clamp comprising:
front and rear clamp components forming a first clamp section, wherein the first clamp section has a center aperture and two outer apertures, each having a diameter, and wherein the diameter of the center aperture is larger than the diameters of the outer apertures;
front and rear clamp members forming a second clamp section having a lower aperture, wherein the lower aperture has a diameter, wherein the diameter of the center aperture is larger than the diameter of the lower aperture, and wherein the center aperture and the lower aperture are substantially coaxial;
first and second flexible bridges connecting the front and rear clamp components to the front and rear clamp members, respectively; and
a plurality of fasteners, wherein the fasteners are tightened to independently secure one or more conduits in the outer apertures and/or the lower aperture,
wherein the first and second clamp sections have a plurality of fastener apertures.

27. The conduit clamp as set forth in claim 26, wherein the front clamp component and/or the rear clamp component has/have a pair of opposing ends that are pivotally connected.

28. The conduit clamp as set forth in claim 27, wherein the opposing ends of the front and/or rear clamp components is/are pivotally connected by a hinge or hinges.

29. The conduit clamp as set forth in claim 28, wherein at least one fastener is associated with each of the outer apertures and tightening the at least one fastener prevents pivotal movement of the associated opposing end.

30. The conduit clamp as set forth in claim 29, wherein the hinge or hinges is/are located about midway between the opposing ends of the front and/or rear clamp components.

31. The conduit clamp as set forth in claim 27, wherein the front and rear clamp components contain one or more inter-mating alignment structures.
